(19) United States
(12) Patent Application Publication
(10) Pub. No.: US 2016/0148546 A1
(43) Pub. Date: May 26, 2016

(54) SIGNAGE SYSTEM

(71) Applicants: Apryl LINK, Omaha, NE (US); Micaela SHARP, Omaha, NE (US)

(72) Inventors: APRYL LINK, OMAHA, NE (US); MICAELA SHARP, OMAHA, NE (US)

(21) Appl. No.: 14/899,502

(22) PCT Filed: Jun. 18, 2014
(86) PCT No.: PCT/US14/43008

§ 371 Date: Dec. 17, 2015

Related U.S. Application Data
(60) Provisional application No. 61/836,231, filed on Jun. 18, 2013.

(51) Int. Cl. G09F 7/10

(52) U.S. Cl. CPC G09F 7/10

(57) ABSTRACT

A signage device is disclosed having a display panel and a mounting member. A storage panel is positioned parallel to the display panel and between the display panel and the mounting member. At least one framing member is coupled to the mounting member and the display panel, and the at least one frame member, the mounting member, and the display panel at least partially define a storage space configured to receive the storage panel.

### CROSS-REFERENCE TO RELATED APPLICATION

This application claims priority to U.S. Provisional Application Ser. No. 61/836,231, filed Jun. 18, 2013, which is herein incorporated by reference in its entirety.

### BACKGROUND

The present disclosure relates to signage systems. In particular, the present disclosure relates to signage systems adapted for multiuse areas.

A multiuse area may be considered an area used for a specific function at a particular time. The specific activities or occupants may change regularly. Such areas may include conference rooms, hospital rooms, rooms within educational facilities, or other areas where it is advantageous to have changeable signage that displays information relevant to the particular occupant(s) of the area or the activities carried out therein.

In general, simple whiteboards, removable signs or placards, or electronic displays have been used for the display of time- or occupant-dependent information near the entrance to a multiuse area. These systems can be cumbersome (and; in the case of electronic signage, expensive). Also, the various dry erase markers may be lost or kept distant from the signage. This makes their use more cumbersome, which results in users not taking advantage of them.

While some efforts have been made to provide signage that is appropriate for a multi-use area, these signs often incorporate only universal symbols or jargon, the meaning of which may not be apparent to all persons to whom the information is relevant. Accordingly, there is a need for multiuse area signage that is easily changed by staff and clear to both staff and lay viewers who may need the information displayed.

### SUMMARY

Some embodiments relate to a sign having a display panel, a mounting member, and a storage panel positioned parallel to the display panel and between the display panel and the mounting member. A framing member may be coupled to the mounting member and the display panel. The framing member, the mounting member, and the display panel at least partially define a storage space configured to receive the storage panel.

### BRIEF DESCRIPTION OF THE DRAWINGS

FIG. 1 is a front elevation view color photograph of a signage system.

FIG. 2 is a right side view color photograph of the signage system of FIG. 1.

FIG. 3 is a left side view color photograph of the signage system of FIG. 1.

### DETAILED DESCRIPTION

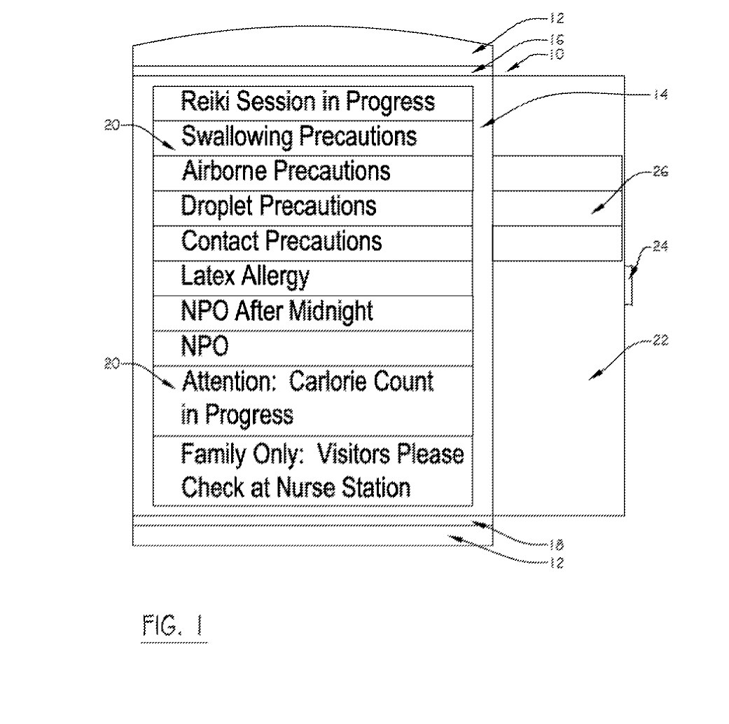

Referring to the Figures, FIG. 1 shows a signage system 10 including a mounting member shown as rear panel 12, a display panel 14, an upper frame member 16 and a lower frame member 18. The wall mounting member may be a panel extending the height of the signage system (as shown), formed as a part of one of the frame members, or extend on partly along the height of signage system 10. In some embodiments, multiple mounting members may be used where one or more are integrally formed with or coupled to the frame members to facilitate mounting the signage system to a wall, door, or other surface. Rear panel 12 may optionally include an arcuate portion positioned near the top of signage system 10 or other aesthetic features. Rear panel 12 may be made of wood, plastic, glass, or other materials suitable for the decor of the area in which the signage system will be used that are sufficiently strong for use in the system.

Display panel 14 is coupled to rear panel 12 by frame members 16 and 18. Display panel 12 may be coupled to frame numbers 16 and 18 by any conventional means, including fasteners and/or adhesives. Display panel 14 may comprise a “whiteboard” or dry-erase board material such that messages may be written on display panel 14 using dry-erase markers. Display panel 14 may also be compatible with magnetic placards 20. In use, magnetic placards may be selected by facility staff to convey messages to persons entering an area adjacent to signage system 10.

By way of example, placards may be removably placed on display panel 14 and signage system 10 placed adjacent to a door. In a healthcare or assisted living facility, the placards may be used to convey roam- or area-specific messages for visitors, patients, and/or facility workers. The placards may include both universal symbols and/or be color coded in a way that would make their meaning immediately apparent to persons familiar with such systems. Additionally, plain, concise language may also be placed on the placards for visitors, contractors, and other persons who may not be familiar with universal symbol or color coding systems. Such signage systems may be utilized in educational institutions, daycares, in conjunction with conference rooms and convention centers, or any multi-use facility where such signage could be used to convey information specific to the occupant or use of a room or area.

In the example of using signage system 10 proximate to or on a hospital room door, the various placards can be used to inform staff and visitors of important information regarding the room or its occupant. For instance, a magnetic placard identifying an allergy, a compromised immune system, dietary restrictions, the need to use protective equipment, or other special circumstances may include a universal symbol for quick identification by hospital staff, along with clear and plain text for visitors. Color coding may also be used with the placards.

As shown in FIG. 3, a storage panel 22 is provided in a storage space interior to signage system 10 and defined in part by display panel 14, rear panel 12, upper frame member 16, and lower frame member 18. Storage panel 22 is slidably coupled to frame members 16 and 18. Storage panel 22 may include a pull tab 22, grip region, knob, or other feature for a user to grasp and slide storage panel 22 into and out of a stored position. Storage panel 22 may be constructed of similar materials to those used in the construction of display panel 14. In some embodiments, storage panel 22 may be compatible with magnetic placards such that those additional placards 26 not in use on the display panel 14 may be placed on the storage panel and retained out of sight, but conveniently adjacent to the display panel 14. Alternatively, additional features such as trays or other structures may be used to retain the stored and unused placards. Dry erase markers may also be stored in trays or be provided with magnets or hook-and-loop type fabric so they may be removably stored on storage panel 22.

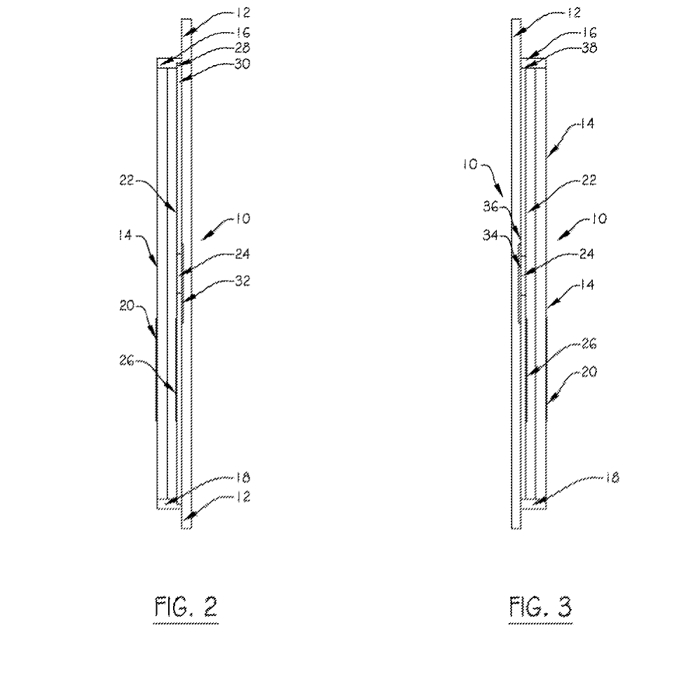

Referring to FIGS. 2 and 3, frame members 16 and 18 may include means for slidably coupling storage panel 22 to the rest of signage system 10. In particular, frame members 16 and 18 may be provided with a channel 28 (shown as a routed groove in upper frame member 16) for receiving an edge 30 of storage panel 22. Alternatively, channel 28 may be formed by constructing frame members 16 and 18 from a plurality of subparts. A similar channel may be disposed in lower frame member 18. In use, a user may grasp tab 24 to slide storage panel 22 out to an open position, remove a desired placard for display, place the place that placard 20 on display panel 12. If needed, the user may place placards that are no longer needed to be displayed on the storage panel, and slide storage panel 22 back into a closed position.

Referring to FIGS. 2 and 3, signage system 10 may be configured to retain storage panel 22 by way of restricting its sliding movement relative to the rest of signage system 10. As shown, projections 32 and 34 may be positioned on rear panel 12 while another retaining projection 36 is positioned on a back side of storage panel 22. At a first extreme position (fully open), projections 32 and 36 are in contact and prevent further lateral sliding of storage panel 22. Conversely, at a second extreme position (fully closed), projections 32 and 34 are in contact and prevent further lateral sliding of storage panel 22 relative to the rest of signage system 10. Additionally, a block 38 may be positioned at a terminus of channel 28. Block 38 may be formed by routing a partial, longitudinal channel in frame members 16 and 18 or positioning a separate piece of material at the terminus of channel 28. Block 38 may be used in conjunction with or in place of projection 34 to restrict movement of storage panel 22 past a point of being in a fully closed position.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

The terminology used in the description herein is for the purpose of describing particular embodiments only and is not intended to be limiting of the invention. As used in the description of the embodiments and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims.

What is claimed is:

1. A signage device comprising:
a display panel;
a mounting member;
a storage panel positioned parallel to the display panel and between the display panel and the mounting member; and
at least one framing member coupled to the mounting member and the display panel;
wherein the at least one frame member, the mounting member, and the display panel at least partially define a storage space configured to receive the storage panel.

2. The signage device of claim 1, wherein the storage panel is slidably coupled to the at least one frame member.

3. The signage device of claim 1, having an upper frame member and a lower frame member positioned substantially parallel to each other.

4. The signage system of claim 3 wherein each of the upper frame member and the lower frame member include a groove positioned between the display panel and the mounting member, the grooves configured to receive the storage panel.

5. The signage system of claim 1, further comprising at least one projection extending from one of the mounting member and the display panel, the at least one projection configured to at least partially restrict movement of the storage panel.

6. The signage system of claim 5, wherein the storage panel comprises a projection configured to engage the at least one projection. The signage system of claim 6, wherein the at least one projection extends from the mounting panel.

8. The signage system of claim 1, wherein both of the display panel and the storage panel include a surface configured to retain magnetic placards.

9. A signage device comprising:
a display panel configured to retain and display magnetic placards;
a mounting member;
a storage panel positioned parallel to the display panel and between the display panel and the mounting member, the storage panel being configured to retain magnetic placards;
a first framing member coupled to the mounting member and the display panel, the first framing member including a groove extending longitudinally parallel to the mounting member and configured to receive a first edge of the storage panel;
a second framing member coupled to the mounting member and the display panel the second framing member including a groove extending longitudinally parallel to the mounting member and configured to receive a second edge of the storage panel; and
wherein the first frame member, the second frame member, the mounting member, and the display panel at least partially define a storage space configured to receive the storage panel.

10. The signage device of claim 9, wherein the storage panel includes a tab for grasping to move the storage panel along the grooves of the first framing member and the second framing member.

11. The signage system of claim 9, further comprising at least one projection extending from one of the mounting member and the display panel, the at least one projection configured to at least partially restrict movement of the storage panel.

12. The signage system of claim 11, wherein the storage panel comprises a projection configured to engage the at least one projection.

13. The signage system of claim 12, wherein the at least one projection extends from the mounting panel.

14. A signage device comprising:
a display panel configured to retain and display magnetic placards;
a mounting member at least one projection extending toward the display panel;
a storage panel having a tab for grasping to move the storage panel, positioned parallel to the display panel and between the display panel and the mounting member, the storage panel being configured to retain magnetic placards;
a first framing member coupled to the mounting member and the display panel, the first framing member including a groove extending longitudinally parallel to the mounting member and configured to receive a first edge of the storage panel;
a second framing member coupled to the mounting member and the display panel the second framing member including a groove extending longitudinally parallel to the mounting member and configured to receive a second edge of the storage panel; and
wherein the first frame member, the second frame member, the mounting member, and the display panel at least partially define a storage space configured to receive the storage panel.
